(19) United States
(12) Patent Application Publication
(10) Pub. No.: US 2003/0115094 A1
(43) Pub. Date: Jun. 19, 2003

(54) Apparatus and method for evaluating the performance of a business

(76) Inventors: Geoffrey C. Ammerman, Duluth, MN (US); Dave S. Purdy, Duluth, MN (US); Chad H. Scott, Two Harbors, MN (US)

Correspondence Address: Kevin W. Cyr, Rider, Bennett, Egan & Arundel, LLP, Suite 2000, 333 South Seventh Street, Minneapolis, MN, 55402, US

(21) Appl. No.: 10/026,153

(22) Filed: Dec. 18, 2001

(51) Int. Cl. G06F 17/60; G06F 11/30; G06F 15/00; G21C 17/00

(52) U.S. Cl. 705/11; 702/182

(57) ABSTRACT

An apparatus and methods for evaluating the performance of a company that provides a plurality of pre-selected responses to each query that are objectively answerable based on observed behaviors of the employee is disclosed. The apparatus includes an input device, a data storage device, a processor and an output device. Further, the apparatus and methods may analyze the evaluation data.

### BACKGROUND OF THE INVENTION

1. Field of the Invention

The present invention relates to an apparatus and method for evaluating a business and, more particularly, to an apparatus and method for objectively evaluating the performance of the business and/or the people working for the business.

2. Description of the Related Art

A businesses' personnel are typically the company's most valuable asset resource. Accordingly, personnel frequently absorb between 50% and 70% of the company's budget. To assure that personnel are functioning optimally in accordance with the company objectives, companies strive to frequently undertake performance evaluations. However, these evaluations are time consuming, can be troublesome, and expensive. Due to these issues, evaluations are not always undertaken on a regular basis. Companies undertake performance evaluations generally once per year. Thus, companies typically do not realize the full benefit of effective regular evaluations of their personnel. Therefore a need exists for an apparatus and methods that provide efficient and cost-effective evaluations of a company's personnel.

Current methods or apparatus for performance evaluations have not used objective behavioral measures to evaluate the performance of individuals or to collectively analyze the performance of a company or its subparts. Although earlier methods have alleged to apply objective measures, the measures are not truly objective behavioral measures. In many cases these objective measures have looked at the end results of an employees behaviors as a tool for evaluating performance. For example, using the number of items sold by a salesperson over a period of time. The number of items sold is a result. A result is a consequence of a set of behaviors that generate the particular result. It could be that several other factors were responsible for the number unsold or that many other variables were at play that created this result. Although the number of items sold is an objectively measurable result, merely stating a result does not provide substantial information to the employer. Particularly, the resulting sales numbers do not elucidate the effective sales behaviors that lead to the sales numbers. An understanding of these behaviors provides valuable information to the employer not only to how and why the employee was excelling or faltering, but also on how the employee's behaviors compare with the company's philosophies, objectives and goals. Therefore, a need exists for an apparatus and methods that facilitate the evaluation of an employee's performance that utilize objective, behavior based measures focused on the developmental steps of the required competencies that are responsible for successful job performance.

Current evaluation methods rely on outcome-based measures to evaluate an employee or organization and its sub-parts. Outcome alone does not measure job performance. Outcome is only one part of the equation, but it is not the entire process.

An example of an outcome measure would be the use of an executive's car being parked in the parking lot of the business for 14 hours per day. The presence of the car could be used as a dependent measure of hard work and dedication of the car's owner. When in fact, the presence of the car could simply mean he is disorganized and incapable of completing his tasks in a normal workday. Alternatively, the presence could mean that the golf course is within walking distance. As one can see, there are as many variables in this type of outcome based measure, as there are people to interpret the information. However, if an objective behavioral base approach was used to track, observe, and evaluate this individual's behavior on the job and his overall job knowledge and application, a set of standards would be in place on which everyone could agree. Then, the outcome of the number of hours his car is parked in the parking lot would have some meaning.

Another example may be found in a U.S. company considered to be one of the top corporations to work for in the country. The vice president of training indicated that 4% to 6% of gross receipts were spent on training for their staff. However, his only indication of training efficacy was the existence of or lack of customer complaints. This indicates that this manager is proud of the amount of money spent on training, and does not indicate the money's direct effect on the intended behaviors that the training was supposed to improve or modify. The outcome measure of customer complaints has no real bearing as to whether or not training is effective. Instead, developing the desired competencies that equals performance, based upon staff and company goals and breaking them down into their component parts and described in a way in which all who are being evaluated could recognize when a good performance occurred, this then would equal a strong developmental and behavioral evaluation that could be linked to a variety of outcomes which serve as dependent measures.

Other outcome-based measures are linked to measuring the completion of a variety of tasks over a given amount of time such as a day, week, month, or quarter. Managers and supervisors will tend to employ different strategies to increase the production of the number of widgets or other articles to be assembled by developing quotas or consequences for not meeting performance goals. Usually the individuals involved do not participate in the setting of goals or in establishing what it takes to be an excellent employee when it comes to putting these things together or becoming a better employee and learning more to improve the system.

Generally, analysis of the performance is done by its senior management and supervisors who only relate this performance to the pressing buttons on a computer interface which is then indicated to be the measure of human performance. It does not take into account knowledge, ability and the desire to improve by the persons performing the job. All it takes into account is a physical act. As can be easily seen in this type of outcome measurement, attempts are made at behavioral observation and measurement. However these methods do not capture the essence of human behavior and its objective measurement within any given organization. Dependent measures alone do not tell the story of human endeavor within any given organizational structure.

Current evaluation processes are subject to the biases of the evaluator. Most companies have their supervisors or managers evaluate the employees under their supervision. However, the supervisors and managers are almost never trained to understand how to fairly and impartially evaluate people. In fact, the supervisors and managers evaluations are influenced by factors that are not in the evaluating company's best interest. This arises because the supervisor or manager has both a professional and, to varying degrees, a personal relationship with the evaluated employee. Both relationships will create bias that either raises or lowers the evaluated employee's review depending upon whether the supervisor respectively, likes or dislikes the employee, or remembers all the positive events that occurred or accurately remembers any negative events that may have occurred within the previous year. Given that human memory only accurately recalls positive events for roughly 7 to 10 days long, an accurate memory certainly plays a role in these evaluations. These biases frequently arise from what the supervisor or manager perceives to be the appropriate work ethic or demeanor for a given position.

These biases are developed throughout the supervisor's or manager's lifetime. However, the performance of an employee as perceived through the biased eye of the supervisor or manager is not always an accurate measure of the performance of the employee. For example, the demeanor and mannerisms of the employee who is shy or lacks self-confidence may lead a supervisor to perceive that the individual is performing at a level below that employee's peers when, in actuality, the employee's performance may be in-line with the company's expectations and, in fact, may also surpass that of the employee's peers who may have received a higher subjective rating. These biases that frequently do not compare with company objectives are not typically removed using current evaluation procedures. Generally, an evaluating supervisor's or manager's personal history, perception of authority, personal perceptions, and belief system intertwine to effect each employee's evaluations in ways that may not be in accordance with the company's interests. Thus, a need exists for an apparatus and methods that provide for the evaluation of employees that is objective and behavioral based that eliminates the bias inherent in human nature.

In addition to the inherent bias of an individual evaluator, there is the possibility that the evaluating individual has not actually observed an individual performing a required task or function for their position. In some instances, the evaluating individual could be inclined to enter an arbitrary answer. This arbitrary answer may or may not have appropriately characterized the evaluated individual's performance. Therefore, a need exists for an apparatus and method to evaluate employees that can exclude arbitrary aberrant responses to increase the reliability and trustworthiness of the data that are collected.

Further, even when aggregated, the subjective differences in evaluations because of differences in the evaluating supervisors and managers limits the value of the aggregated data. Therefore a need exists for an apparatus and methods to facilitate the objective review of employees and that permit the aggregation and analysis of the dollar with data over any given time period specified.

In addition, many prior performance evaluations inherently suffer from the need to remember the events from which an individual is being assessed. That is, human memory has limitations that typically allow an individual to retain a positive event for only between 7 to 10 days but can allow that individual to retain a negative event for one or more years. Thus human nature tends to blow negative events out of proportion tending to remember the negative events that will inevitably color an individual employee's performance evaluation. Thus, a need exists for an apparatus and methods that allows an evaluating individual to base his or her evaluation on objective behavior based criteria that minimizes the limitations of an evaluator's memory.

Currently, objective behavioral measures are not utilized for performance evaluations. Typically, performance evaluations that purport to utilize the behavioral data concerning the employee employ a frequency based data system such as supervisors making check marks on a clipboard when reviewing employee's behavior. This is called a time sample. Other performance evaluations track the number of computer commands used on a given machine to determine the effectiveness of a particular machine operator and will not engage the knowledge or the developmental processes that a machine operator would go through to make the choices he does in running a complex machine. Particularly, prior evaluations of employees in technical positions have focused on the what and not the how or the why. When establishing production goals, companies typically have not utilized staff participation in setting up the parameters for the goals. Data collected in competency, positive characteristics or reinforcement strategies are not noted with only simple tabulation being the method of measurement of choice. The problem remains that these other attempts at performance evaluation that are computer based are not computer friendly, are not used in the clear language for the staff to participate, evidence no behavioral terms or with no work definitions clear although they are implied.

Prior methods also identify performance analysis and evaluation from a knowledge-based perspective. This knowledge based process is based upon pre-existing expectations of knowledge in a given profession or technical field which may or may not be correct for an individual user. As well, these values are not statistically designed and are generally poor when it comes to behavioral descriptions. This knowledge benchmarking is generally from organizations that may or may not be consistent with the work of those to which it is being compared. These measures are inherently and consistently opinion based such as rating an individual's knowledge on a 1 to 5 or 1 to 7 point scale on a continuum. Also, the prior methods do not assess how specific behavior or knowledge for the evaluation is demonstrated or known. This knowledge cannot easily be translated into a hands-on application into the area or job to which the knowledge is being attributed.

Prior performance evaluations and assessments typically suffer from the use of immeasurable statements and the use of rating systems that are opinion based on a 7-point scale. The 7-point scale uses the number “1” to equal a rating of “poor” up to the number “7” to equal a rating of “excellent.” What is inherently problematic is that one individual's rating of “poor” and another individual's rating of “poor” is inherently flawed and will not be the same. This type of data analysis frequently does not survive the rigors of statistical reliability between evaluators or, in other words, an inter-rater reliability. This means, if two people were to observe any given behavior they would agree at least 90 percent of the time that they were seeing the same thing. In using the current art, the variation of the data that are possible is too great with the result being that the organization ends up tracking the opinions and beliefs of the rater and not the behavior of the individual being rated. These types of evaluations are inherently flawed and useless measures. For example, current art utilizes a rating system of 1 to 7 on a management tool which uses the phrase, “uses innovative thinking to solve complex problems.” It is unlikely that anyone would rate this the same from one month to the next without having a list of definitions to underscore the foundation of what this particular characteristic would look like when observed by two individuals watching this “behavior” occurring within the natural environment. Without a prescribed context, this particular statement has no meaning whatsoever. It is purely subjective and the definition of “defining innovative” as well as, “thinking,” or defining “complex” or even defining, “problems.” Without a list of characteristics to define this complex characteristic, and certainly a desired characteristic, not one person within this organization would be able to evaluate and measure this the same way twice.

As a result, this type of evaluation has no real impact on the intended environment or organization because two people reading this characteristic would never be able to agree and create reliability without user defined terms that characterize the existence of innovation, complexity, thinking, or problem solving into a standard cognitive developmental application. This type of evaluation has no integration of behavioral measures or any form of inter-rater reliability as discussed earlier. Prior method utilize processes that are nothing but nebulous or merely defined with current evaluations which are no more than estimating frequency with a random number assigned to that behavior which in turn is statistically analyzed. This creates a false sense of data analysis and which truly there are no hard and fast facts concerning the actual behaviors that are effecting the overall environment of any given organization. What is troublesome is that these processes are called “behavioral data.” In fact they are worse than educated guesses.

Current methods identify surveys and evaluations that are created based upon opinion not behavior. Evaluation terms such as “generally agree” or “generally disagree” are not a behavioral assessment. However, behavioral characteristics are identified although are not measurable behaviors. Terms that are in constant use are “understandability” and “credibility” which are in turn rated from 1 to 7. Current art attempts to use repeated surveys to generate some form of benchmarking and statistical measure. However it only tracks how people respond to surveys and general knowledge and not to the intended object of the evaluation or survey. Current art doesn't use the gathered data to compare peers or to use as a method of growth or improvement. It is only used to set normative and criterion references from outside sources to see what they know or what they think. None of the behaviors are internally generated or data specific to the organization with no statistical behavioral analysis attempted. The organization then uses these measures to govern change when the measures that are selected are not truly an indication of their effectiveness as a group, team or organization.

Still other prior performance evaluations are structured around nebulous rating scales. These scales often require the evaluator to provide an opinion of whether an employee “exceeds expectations,” “meets requirements” or “needs improvement.” Yet other scales provide responses such as “usually,” “sometimes,” or “never” and still others provide for responses such as “consistently” or “regularly.” None of these responses is extremely useful to the company due to their subjective nature that in turn contaminates any analysis based upon such responses. Yet from evaluations using such responses, companies purport to measure and assess job performance and behavior. Therefore, a need exists for a method and apparatus for evaluation that takes knowledge from within an organization and breaks it down into specific observable behaviors that are consistently applied across environments that can be identified by everyone.

Companies have used 360-degree evaluations to assess the performance of teams of employees. However, the 360-degree evaluation in its current form causes more enmity than creating teamwork. Many 360-degree assessments assess personal attributes of each individual and are not focused on the specifics of the jobs as a whole. These types of team evaluations create long-term disruption and animosity within a variety of teams depending upon how well the team is prepared for the use of such a evaluations and how much they may have contributed to its development. Most 360-degree evaluations however, are developed outside of the work environment and then are applied to the environments as a whole, not taking into account the individual nuances of any given organization or any of its sub-parts. Examples of 360-degree surround evaluating personal dress, a person's breath, their beliefs, with a couple of questions as to their teamwork and job responsibility. Further, 360-degree evaluations are done in a pencil and paper process with the data collated by a manager which is distributed to all the team members within a given work department. The purpose of this is to create open communication and teamwork. However, it typically creates animosity. The utility of this data is very limited. Therefore a need exists for an apparatus and method that permits the objective evaluation of employees by their peers that is confidential and sticks to the job performance and its contribution to the company and its sub-parts.

Furthermore, current performance evaluations have largely remained a paper-based process essentially using a 19th century process to evaluate the 21st century work force. The paper-based nature of these evaluations has prevented their efficient use for data collation due to the time and cost to compile such evaluations. Therefore, a need exists for an apparatus and methods for collating and analyzing the data that avoids the costs and time associated with the collation and manipulation of paper based evaluations.

Some companies utilize software applications to evaluate their employees' performance. Although these software applications have permitted the computerized evaluation of a company's employees and the storage of all the evaluations, these software applications do not eliminate the subjective nature of evaluations themselves. They essentially computerized the same ineffective rating scales and evaluations that are currently used on paper. Therefore, a need exists for an apparatus and methods that allow the convenient evaluation of employees that provides a reliable objective evaluation.

Additionally, all the attempts at computerized employee assessment do not reflect any impact on the overall performance evaluation. References to this are certainly made, however, in practice from observation and looking at the past art there is actually no incorporation of behavioral measures or attempts at these computerized measures to incorporate an overall performance evaluation. These paper and pencil-based processes use poor measurement such as not applicable, unsatisfactory, below average, above average, and excellent. Attempts are made to create statistics out of these guesses about behavior that cannot meet the test of true inter-rater reliability. No aggregation of data is identified with any relation to compensation or behavioral links to existing measures of organizational productivity profitability exists in current art utilizing computerized evaluations. There is no departmental or inter-departmental comparison, no human resources standardization of data, no true criterion or normative references with none of these computerized applications even beginning to disclose the use of an application service provision or establishing a customized behavior platforms.

Statements concerning behavior within organizations are made, however, nothing measurable exists in the previous art when it comes to human behavior. In these prior methods, only the supervisor and the employee determine the standards with no mention of overall expectations and obligations to the organization as whole. As a result, tremendous variance and interpretation and implementation occur. Not being behaviorally based sets up measures of completion of activities that are essentially a value judgment with a value attached. There is no employee evaluation and comparison with peers using the same criteria with every employee possibly having a different set of standards based on the implementation as allowed by the present art.

The assignment of point values to value judgments created cumbersome paper-based process or cumbersome computerized paper-based process in which the previous art readily admits that subjectivity and accuracy of paper work, even though it claims to solve employee problems quickly, has no organizational data analysis or standard creation. Even though this performance evaluation would be computerized and not may or may not fit within the overall department organizational goals. As a result, the previous art's attempts at behavior measures are subject to manipulation by the supervisor over staff, which can set up potential discrimination. Earlier methods do not utilize a cooperative venture with the employees or actually doing the work that is involved in the evaluation process. All of these evaluations are prescriptive and are “top down,” this means the evaluations are created in a vacuum outside of their intended environments that they will evaluate. This also indicates employees are not participating in developing the standards or setting the standards to which they will be adhering. There is, as a result, a rotation of standards by the supervisor placing their own interpretation of the data or the organizational expectations.

Unfortunately, personnel frequently dread performance evaluations. These evaluations being viewed by personnel as a potential source of humiliation and, in some cases, a possible realization of an individuals inadequacies such as underdeveloped skill sets or inadequate knowledge for their particular job or position. This is a source of stress that can reduce the employee's performance in the time leading up to the evaluation in anticipation of the evaluation, and can reduce their productivity after evaluations because of feelings of incompetence. Therefore, a need exists for an apparatus and methods for undertaking the evaluation of a company and its employees that is relatively inexpensive and easy and does not create unneeded stress in employees.

An evaluation of a particular department, a division, or even the company as a whole using a list of the performance of the individual employees would provide a valuable tool for assessing the particular strengths and weaknesses of the company or its sub-parts. Prior software programs and computer systems for employee evaluation have not provided the ability to aggregate the performance of individuals within the company or some part of the company with objective data. Therefore, a need exists for an apparatus and methods that allow the aggregation and analysis of evaluation data on employees performance within a company or its sub-parts and, further, a need exists for reporting systems that mine down the data clearly identify training issues for individuals and within a department or work unit the reports also identify key demographics that assist in recruiting and hiring.

Generally, those who developed prior evaluations typically had little or no training in the assessment of human behavior individually, in groups, or in organizations as a whole. Attempts have been made to make evaluations relate to outcomes that appear to make sense to the evaluator, not realizing that these two events, human and outcome studies are only marginally related most all of the time.

Finally, knowledge based assessments attempt to capture the essence of competencies and in some cases come rather close. However, that rating systems employed to assess this knowledge within the intended environment suffer the same flaws as current performance evaluations. The knowledge may be assessed effectively, but its overall impact on the organization is not. Again, the reason is that most all individuals are rarely if ever dipped in the brine of behavioral psychology and therefore are not aware of the flaws inherent in performance evaluation systems.

### SUMMARY OF THE INVENTION

Embodiments of the present invention meet the above needs and provides additional improvements and advantages that will be recognized by those skilled in the art upon review of the present disclosure. The present invention provides an apparatus and methods for evaluating the performance of a company that provides a plurality of pre-selected responses to each query that are objectively answerable based on observed behaviors of the employee and provides an apparatus and method for the analysis of evaluation data. The present invention provides some method and apparatus to objectively, fairly, and impartially measure performance evaluations to base promotion performance on actual data. In one aspect, the present invention provides an apparatus for evaluating a business. The apparatus including an interface, a data storage device, a processor, and an output. The interface to presents a plurality of inquiries regarding the performance of an employee of the business and to receive a pre-selected behavior based response for each of the plurality of inquiries. The behavior based response is selected from a plurality of a behavior based responses provided with each of the plurality of inquiries. Each of the a behavior based responses is assigned a value. The data storage medium is coupled to the interface to receive and store the value for each of the a behavior based responses. The processor is coupled to the data storage medium to retrieve the values and to transform the values into at least one measure of performance. The output coupled to the processor to provide the at least one measure of performance in one of human readable form and machine readable form. The measure of performance may be one or more of an individual employee's performance, a departmental performance average, a division performance average, a company performance average, an identification of training need, an indicator of training effectiveness, an action plan for the employee, an action plan for the department, an action plan for the division, an action plan for the company, a comparison of current performance with past action plans, a comparison of aggregated data over time for the employee, a comparison of aggregated data over time for the department, a comparison of aggregated data over time for the division, or a comparison of aggregated data over time for the company.

In another aspect of the invention, a computer readable medium storing a computer program for evaluating a business is disclosed. The program presenting a plurality of inquiries regarding the performance of an employee of the business. The program provides a plurality of behavior based responses to each of the plurality of inquiries. The program assigns a value to each of the plurality of behavioral based responses. The value indicative of the desirability to the company of the response. The program stores the values. The program then retrieves the stored values to transform the values into at least one measure of performance.

In yet another aspect of the present invention, the invention provides method for evaluating a business. The method includes providing a plurality of inquiries that evaluate an employees performance. Providing a plurality of behavior based responses to each of the plurality of inquiries. The plurality of behavior based responses being indicative of an objectively measurable behavior threshold. Assigning a value to each of the plurality of behavioral based responses. The value indicating the desirability of the behavior based response to the company. Storing the values. Transforming the values into at least one measure of performance.

### BRIEF DESCRIPTION OF THE DRAWINGS

FIG. 1 illustrates a block diagram of an embodiment of an apparatus in accordance with the present invention.

### DETAILED DESCRIPTION OF THE INVENTION

The following discussion generally describes the present invention implemented in the context of the health care environment. Those skilled in the art will recognize that the present invention has much wider application and that the present invention may be implemented in a wide variety of businesses to evaluate the businesses' performance and the performance of its people without departing from the scope of the present invention. However where particular examples are provided, the following disclosure generally describes the invention in the context of a health care provider for consistency, ease of description and clarity.

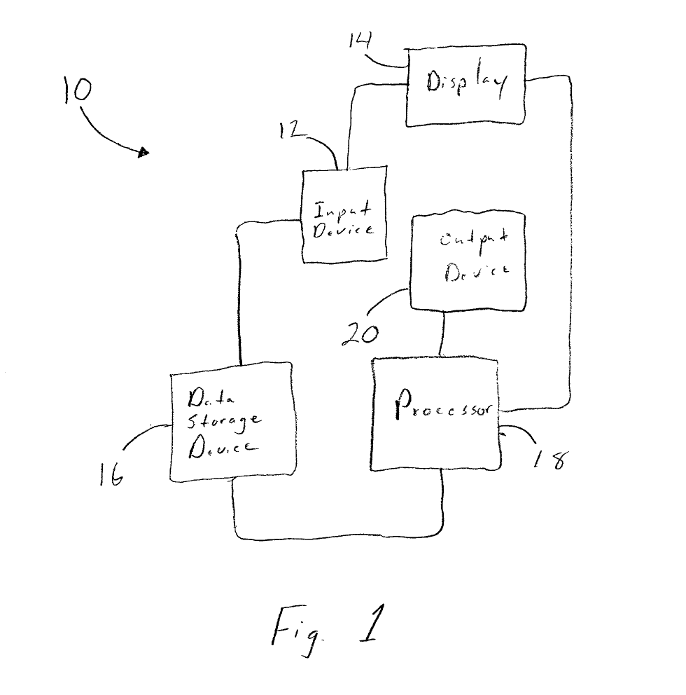

FIG. 1 illustrates an apparatus 10 in accordance with the present invention. Generally, apparatus 10 is configured to receive input from a user to evaluate an employee of a company or business. The input is a response to questions regarding a behavior of the employee. The response is selected from a plurality of possible responses with each of the responses quantifying an objectively observed behavior. Apparatus 10 generally includes an input device 12, a data storage device 16, a processor 18 and an output device 20. Input device 12 is configured to receive input indicative of or response to a question presented to a user. As illustrated, a display 14 may also be provided to present the questions and/or responses to the user. Typically, input device 12 is in the form of a keyboard or touch-pad, but the input device may take a variety of forms as will be recognized by those skilled in the art. Apparatus 10 can be hardwired or provided with software that present the series of questions and responses in accordance with the present invention. Input device 12 communicates with a data storage device 16 to transfer data indicative of the user's response from input device 12 to data storage device 16. At least one data storage device 16 stores data input for each question from each of the one or more users evaluating an employee. At least one data storage device 16 may also store and transmit the questions and responses to display 14 where the questions and responses are displayed in a user viewable format. A processor 18 communicates with data storage device to retrieve and process the individual and aggregated stored output. Processor 18 communicates with an output device 20 or may communicate with display 14 to convey the processed information in a human or a machine-readable form. The various devices may communicate with one another using hardwiring, telephone modem, broadband technologies, wireless technology, the internet or by other methods that will be recognized by those skilled in the art upon review of this disclosure. Further, apparatus 10 can be hardwired or provided with software to enable processor 18 to analyze the cumulative evaluation data entered into apparatus 10 and stored in data storage device 16 as is desired by a particular company or industry.

In one form, apparatus 10 may be a personal computer. When apparatus 10 is a computer, input device 12 is typically a keyboard or touch sensitive screen. Storage device 16 is typically the hard drive of the personal computer. Processor 18 is typically the central processing unit (CPU) or other processors in the computer. The entered data is processed by the CPU and in some cases by the additional processors and is stored on a hard drive of the computer. Display 14 and output device 20 are typically the monitor of the computer.

In another form, apparatus 10 may be a personal computer, a plurality of personal computers communicating with one another through a telephone modem, all local area network, a wide area network, or otherwise as will be recognized by those skilled in the art upon review of the present disclosure. When apparatus 10 is a plurality of computers, input device 12, display 14, data storage device 16, processor 18 and output device 20 as utilized to practice the present invention could be located on any of the computers communicating with one another to form apparatus 10.

d. As an ASP

In yet another form, apparatus 10 is in the form of an Internet server communicating with users through the personal computers, personal digital assistants (PDA's) or other devices of the users. The internet server is permits the centralized storage and processing of data and therefore functions as data storage device 16, processor 18 and output device 20 of apparatus 10 whereas the personal computers, personal digital assistants (PDA's) or other devices of the users may function as input device 12 and display 14. In addition, the Internet server may implement the present invention as an application service provision (ASP). As an ASP, apparatus 10 hosts and manages the software applications on the Internet for end users. Thus utilizing an Internet server as an ASP prevents the end user from having to install the necessary software on a hard drive or server. In addition, the Internet server can store, aggregate and process all data entered by users without having to use the processor of an end user. Further, passwords, user names, and other security measures may be provided to regulate access to the software and stored data. Such security measures maintain the confidentiality of the data stored on the Internet server. Further, locating the software on an Internet server functioning as an A S P allows for centralized data storage. Centralized data storage permits the ongoing development of a company's or an industry's database and the analysis of the cumulative data. Thus the Internet servers enable a company to more accurately and efficiently assess the performance of its employees both cumulatively and individually and over time.

An Internet based system may also include additional features. The system may alert users using e-mail when evaluations are due and when evaluations are completed. Further, upgrades to software installed on users' devices if necessary can be easily installed and upgraded without requiring acquisition and installation of the software in tangible form by the end user.

2. Formulation of the Questions

a. Form of the Question

The present invention utilizes questions formulated to require a response that is an objective measure of behavior. In particular, a plurality of objective behavior based responses is provided. The questions and the behavior-based responses are established based upon the requirements given by a particular company, its employees, or industry for performance for the particular position held by the individual being evaluated.

The expectations for similar positions in different industries and/or different companies are frequently different and, therefore, evaluations should be tailored to the particular company or at least the particular industry to most accurately measure performance. Although the development process is custom tailored to each industry, the method of evaluating employee performance through a standardized behavior based evaluation remains constant. To particularly tailor questions and formulate behavior based responses, the following four steps can be followed:

1. Clarify the standards of the company or industry for good performance in a particular position;

2. Identify the behaviors whose proper execution are vital to the standards for good performance;

3. Identify the action whose successful execution should maximize the probability of the success for each behavior; and

4. Construct a plurality of responses demonstrating various levels of performing the identified behaviors that:

a. Expresses a discreet and observable level of performance; and

b. Differs from the other responses in some measurable aspect.

Once the behavior-based responses have been established, each of the behavior-based responses is assigned a numerical value based on the number of responses. For example, the numerical values can range between 1 to 5 when five responses are provided to allow the quantification of a user's responses.

The responses are established using positive assessment sequences the lowest scored behavior consistent with what a new person or new graduate would be expected to do under the established conditions or parameters of the position requirement. The middle scored behavior to be consistent with minimum expectations to do the job within a given organization. The top score 5 indicates the penultimate expectation of exceeding success criteria. For example, the insertion of behavioral observation statements is formatted into this database with the assignment of a 1 to 5 scale as follows:

1) Does not meet success criteria with one or more directional queues;

2) Meets success criteria requiring one or more directional queues;

3) Meets success criteria requiring zero directional queues;

4) Exceeds success criteria requiring one or more directional queues; and

5) Exceeds success criteria requiring zero directional queues.

This is to establish standards in and amongst all departments and different parts of the organization so that organizations and departments may compare themselves to one another and look at what their rating scale is compared to the compensation and customer satisfaction versus other departments or divisions and other organizations who use the same system.

The development of the questions and responses to evaluate employees using the above-outlined four steps can be accomplished through direct interaction with individuals in various positions throughout the company. For example, human resources may be contacted to establish the demographics that need to be collected. Each contact person the company can serve as a liaison to help establish contact with each of the departments to be evaluated and which ones were going to be building the performance of a liberation system. A plan of action can be established on how best to begin the process. A starting point and a map to the entire organization to completion can be made with the type and number of reports desired for the organization as a whole and by each area and department and area of organization that can be updated and amended as each department is consulted on the development of the software.

Staff within each department can be met with while the staff's work is being done to minimize disruption. A standard can be set based on data that are collected from existing performance evaluations, organizational expectations, and from staff expectations. Various managers and supervisors who must adhere to certain guidelines as well as their staff adhering to guidelines such as outside regulatory bodies begin these guidelines and establish the parameters for their individual staff and themselves to work within. A standardized questionnaire can be developed to which all behaviors are identified that establish the expected performance. As a performance expectation levels can be established through interaction with staff that determine the exemplary parameter and the new hire parameters. Staff and supervisors can set the areas from minimum job expectations alike. Staff can be trained as far as what behavioral psychology requires as far as measurable statements and measurable statements can be agreed upon by consensus. These statements can be put before the staff draft by draft until the behavioral measures are established.

A new evaluation can be created for each position description, continuing with the current position description as a foundation with staff input. The performance can be standardized for each group using the performance analysis chart. This chart can identify performance expectations overall, can establish the level of competency; can establish the characteristics and then the target behaviors within each characteristic. Behavioral criteria for each area is then identified with the set the growth continuum established, as described above, from the new person/new grad to exemplary performance set by staff and organizational parameters. Measurement criteria is then set by cooperation between management and staff and electronic transfer data to web developer for the purposes of transferring these evaluation statements into an electronic format for web based evaluation and ASP development.

A dry run of the software may be performed. In the dry run for the department and staff to participate in the data reviews of the statements and the relevance of the statements, adjustments may be made as needed, report parameters are then set in pyramidal fashion in that the user name and password protection determine the level of ability to see the type of data that are made available through this evaluation process. Staff will be able to see themselves and how their peers and customers see them, supervisors will see their unit as a whole, management sees their department, with senior managers seeing a division and vice presidency, and scope and status of the organization depending upon the organizational culture, individuals to see other parts of the core issues depending on what their expectations and needs are. Specific reports can then be determined, with links to the organization's intranet to the performance evaluation site that can provide a seamless connection. At this point, the software is implemented for this department. The next department is then addressed and repeats the steps to completion. Numerous departments can be worked on at the same time. Follow-up data management may be performed upon completion to assure that the system is constantly upgraded and protected through a variety of encryption technologies that meets the HIPPA requirements for data privacy.

An exemplary method for establishing a question and an exemplary question in the area of health-care to evaluate an individuals overall “knowledge of fetal monitors” using performance based measures can be as follows:

A list of peers currently working to assist in defining this knowledge of fetal monitors would be created. All the behaviors and characteristics of the knowledge of fetal monitors and its application is derived from the staff that applies fetal monitoring to patients, interprets its information and use it in overall patient care. Organizational expectations of competency as well as staff expectations of competency are included in the development of the continuum of knowledge and peer expectations in this important area of patient care.

The overall title of the performance characteristic “knowledge of fetal monitors” is a compilation of five lists of user-defined behaviors that describes exemplary performance down to performance experience by a new person or new graduate on this given unit.

The breakdown of the number 5 could be, for example, applies fetal monitor, interprets and responds to obtained information and reports to peers and physician;

The breakdown of the number 4 response could be, for example, applies fetal monitor interprets and responds to obtained information after consulting with peers;

The breakdown of the No. 3 response could be, for example, applies fetal monitor obtains accurate reading for physician evaluate;

The breakdown of the number 2 response could be, for example, applies fetal monitor without assistance; and

The breakdown of the number 1 response could be, for example, applies fetal monitor with assistance.

These behaviors are derived from cooperative interventions that define an organization based upon those who experience it and those who live with it. These tend to become a constant by which all individuals can be measured consistently and fairly creating a reliability between evaluators that can clearly indicate the trustworthiness of the data obtained and be used in peer to peer evaluation in a confidential and job focused 360-degree type of evaluation that relies on an objectively derived data that is cooperatively evaluated and consistently applied to all persons working within any given area.

Traditional performance evaluations that have had “knowledge of fetal monitors” with the rating of 1 to 5 or 1 to 7 where you rate them as not knowledgeable to very knowledgeable. Using the outlined steps, a unique series of questions and responses is thereby created for application each position within the company or industry.

For each area that needs to be covered in a given performance by any given job expectations, this question process is applied to it. The characteristics of the jobs are clearly defined by the organization, the employees will be evaluated and the supervisors and peers will be doing the evaluation. Each and every characteristic of every job is to find in this manner. The initial outlay of time and work to develop these initial questions is substantial. However, following the same approach as outlined above to cover each area the evaluation process becomes a consistent methodology of evaluating the single most expensive line item in any organization's budget which is their staff.

To continue the questioning strategy, methodologies are put into place that link customer or patient experienced with the specific behaviors that are evidenced by staff and how they directly affect them. That is, the staff could be questioned concerning patient education while asking the patience about their education experiences as provided by nursing and hospital staff in general. The same parameters would be used to compare staff responses and patient responses thus generating a coefficient that would show how close the staff perceptions people those of the patients who experience their work. Simply in of formula, this is expressed by the staff average/patient average that equals a coefficient with 1.00 being an exact match.

Process for Using the Hardware and Software

In use a variety of protocols could be utilized. The following represents an exemplary series of steps for utilization of the present invention.

a. Logging onto the System

Logging onto this system would be accomplished by clicking a hyperlink on the intranet screen of any given organization. Upon doing so, a simple user name box and password box will appear. An individual doing the evaluation will type in their user name and password that will allow them to do evaluations that their user name and password will allow them to do. The user name and password assigned determines level of access to the system. The same is true when seeing the level of reports.

b. Presentation of the Questions

The questions are presented one at time with the behavioral definitions randomly ordered on the screen to control for repetitive response patterns.

c. Entering a Response

When entering a response, the user will take a mouse and a pointer process and select the response that most closely defines the behaviors that are observed and that most closely defines the characteristic identified in the evaluation. Once each question has been responded to, the individual will click the “submit responses” button. This action sends the collected data to the database upon which it is instantly assessed and analyzed and ready for reporting.

d. Storing the Responses

The data are stored on data storage device 16 that accumulates responses as a database for each individual area that is assessed for each organization. The data are stored in a minimum of four levels deep that allows for the classification and reporting of the obtained information. These data are instantly available for reporting purposes.

4. The Analysis of the Data Collected

This software creates statistically sound reports that are aggregated over time and creates comparison reports in and among staff, departments, and organizations. At the outset the raw data input from each user is stored in data storage device 18 and is processed to exclude aberrant data. Typically, a statistical reliability between evaluators of 0.85 or greater is desired with any data falling below this threshold typically excluded. This threshold of reliability between evaluators is at 0.85 to assure that the behaviors are quantifiable and are not subject to opinion. The resulting data is then stored in data storage device 16 for further analysis.

To achieve this inter-rater reliability 0.85, the software identifies agreements amongst peers, self-evaluation, and supervisor re-evaluation of the same data for everyone to respond to in the questions. Everyone reads and evaluates each other and supervisory rates zero individuals and their department using the same behavior statements. Where pure, a self and supervisor agree that is considered an agreement. If one of them does not select the same item within a given evaluations statement, that is considered a disagreement. The formula for inter-rater reliability is agreements/agreements+disagreements. This creates the coefficient required to obtain the 0.85 reliability factor. The quantification of the steps of one through five assist in the collection and collation of these reports to determine consistency within and between departments of any given organization and also compares divisions within any large organization utilizing consistent data.

In order for organizations to create action plans for their future, the use of consistent, behavior-based analysis of the people within the organization provides the clearest indicators as to where and how an organization must proceed and ordered to be more effective with its people with its mission with its customers and its future.

The resulting data from these reports is then stored in a data storage device 16 for further analysis. Among others, the following analyses may be performed by apparatus 10:

1. Reviewing the cumulative responses to the performance evaluation for that particular employee can generally assess the individual and employee's performance. This is the basic performance report that covers all areas assessed in each area of the job. The data is manipulated by averaging self-response over time, peer responses over time, and supervisor's response over time while generating the inter-rater reliability coefficient. This takes the place of the typical annual performance evaluation.

2. The departmental performance average can be generally assessed by combining the cumulative responses to the performance evaluation for each individual and a department. This is done to determine the department effectiveness and overall performance relative to the specific behavior required to effectively do the job. It is also used as a method satisfaction of employee's performance with customers. The same reliability factors as in the individual employee's performance processes may be involved. The averages taken over time are used to determine specific goals and objectives within a given department.

3. Combining the cumulative responses to the performance evaluation by each department within a division can generally assess the division performance average. This is through combining the current cumulative responses of each department individuals into a department average that is then used by each department to combine into a divisional average. This is done to determine the divisional effectiveness an overall performance relative to specific behaviors that are required to effectively measure the mission and objectives of the division can be used as well as a method to determine satisfaction of the employee's performance with customers. The same reliability factors as in the individual employee's performance processes may be involved. The average taken over time is used to determine specific goals and objectives within a given division.

4. Combining the cumulative responses to the performance evaluation for each individual in the company can generally assess the company performance average. The corporation or company responses combine into a company average does this through combining the current tool into of response as of each division and its individual into a division average, which is then used. This is done to determine the corporate effectiveness and overall performance relative to specific favors and goals and mission the required to effectively measure the mission and objective of the corporation company. As well as a method of measuring customer satisfaction in the way employee's performance impacts customers. The same reliability factors as in the individual employee's performance processes may be involved. The average stay in overtime are used to terms of the goals and objectives within the corporation.

5. Taking this statistical average reliability factor of 0.85 or greater of all identified performance areas and characteristics that had 3.0 or less creating a list of individuals who scored at this level can generate the identification of training needs. This then pinpoints specific training needs for each individual department division and corporate revenue than sending everyone to training when may be only 15 a 20% actually need it.

6. The indicator of training effectiveness can be generated by tracking the specifics and characteristics of the behaviors that are trained as applied to the job as a whole. The same self, and supervisory evaluations are used to track peer, in arrears that were the subject of training. Overall leadership training can be identified through behavior specifics within the performance evaluation linking it to specific training to tracking in the same fashion. The same reliability factor of 0.85 is at play with these data reported upon as previously identified.

7. Identifying specific behaviors the need developed for effective job performance can generate an action plan for the employee. These behaviors are identified like any other and placed within the software protocol for observation and tracking. The action plan to also be identified from a variety of behaviors scored at 3.0 or less than are slated for development and improvement or is new competencies and need be learned by all and are tracked using the same process.

8. An action plan the department a generated by summarizing newly required competencies or behaviors scored at 3.0 or less and meets reliability standards as indicated which are cumulative individuals within the departments. This aggregate action plan for the department can summarize the overall department's needs, customer needs or overall mission and vision accomplishment.

9. An action plan for the division can be generated by utilizing the same processor in summarizing the department's plan needs and generating overall goals and objectives for each division based upon these data.

10. Summarizing the divisions through utilizing the same data collection generates an action plan for the overall organization or company and analysis procedure previously identified for individuals, applies the organization as a whole.

11. A comparison of current performance with past action plans can be generated by simply calling up reports with a given time. Comparing it to data collected in the most recent month, week, quarter or year. The same rigors of reliability are required to acquire the statistically relevant information.

12. A comparison of aggregated data over time for the employee can be generated or the year in service and picking out critical time periods evaluation and compared to the most recent data. This is done by simply selecting required information and identifying the time periods involved. This data is summarized with the specifics of strengths and weaknesses identified.

13. A comparison of aggregated data or time for the department can be generated by selecting the department averages over time to be evaluated which can be broken down by quarters by months or by year depending upon the needs of the user. The same statistical rigors apply to these data.

14. A comparison of aggregated data over time for the division to be generated by selecting the divisional averages over time to be evaluated and can be broken down by quarters, by months, or years with the vendor upon needs of the user. The same statistical rigors applied to these data.

15. Selecting the same data parameters as in all the other reports by selecting the time period in which the evaluation is to take place, the reports to be generated can generate a comparison of aggregated data over time with the company. These data must meet the same requirements as all the reports.

16. An analysis of rule compliance can be generated by identifying the specific behaviors and conditions and characteristics that are assess through individuals' behaviors such as safety compliance and other rule compliance by tracking those specific behaviors and selecting them for specific reporting for rule compliance. The same statistical rigors are required report. The compliance of rule and national standards are embedded within each and every position description and thereby performance evaluation. Therefore specific rule compliance is maintained through scoring of 4.0 or more in any of the performance requirements for each individual job.

Further, the software also can be linked to compensation strategies, and other software gathering and data collection devices to integrate performance with all aspects of organizational life.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. An apparatus for evaluating a business, comprising:
an interface to present a plurality of inquiries regarding the performance of an employee of the business and to receive a pre-selected behavior based response for each of the plurality of inquiries, with the behavior based response selected from a plurality of a behavior based responses provided with each of the plurality of inquiries and with each of the behavior based responses to each of the plurality of inquiries being assigned a value;
a data storage medium coupled to the interface to receive and store the value for each of the behavior based responses; and
a processor coupled to the data storage medium to retrieve the values and to transform the values into at least one measure of performance
an output coupled to the processor to provide the at least one measure of performance in one of human readable form and machine readable form.

2. An apparatus, as in claim 1, wherein the at least one measure of performance is individual employee performance, a departmental performance average, a division performance average, a company performance average, an identification of training need, an indicator of training effectiveness, an action plan for the employee, an action plan for the department, an action plan for the division, an action plan for the company, a comparison of current performance with past action plans, a comparison of aggregated data over time for the employee, a comparison of aggregated data over time for the department, a comparison of aggregated data over time for the division, or a comparison of aggregated data over time for the company.

3. A computer readable medium storing a computer program for evaluating a business, the program comprising the steps of:
presenting a plurality of inquiries regarding the performance of an employee of the business;
providing a plurality of behavior based responses to each of the plurality of inquiries;
assigning a value to each of the plurality of behavioral based responses, the value indicating the desirability to the company of the response;
storing the values; and
transforming the values into at least one measure of performance.

4. A computer readable medium, as in claim 4, wherein the at least one measure of performance is individual employee performance, a departmental performance average, a division performance average, a company performance average, an identification of training need, an indicator of training effectiveness, an action plan for the employee, an action plan for the department, an action plan for the division, an action plan for the company, a comparison of current performance with past action plans, a comparison of aggregated data over time for the employee, a comparison of aggregated data over time for the department, a comparison of aggregated data over time for the division, or a comparison of aggregated data over time for the company.

5. A method for evaluating a business, comprising:
providing a plurality of inquiries that evaluate an employees performance;
providing a plurality of behavior based responses to each of the plurality of inquiries, the plurality of behavior based responses indicating an objectively measurable behavior threshold;
assigning a value to each of the plurality of behavioral based responses, the value indicating the desirability;
storing the values; and
transforming the values into at least one measure of performance.

6. A method, as in claim 5, wherein the at least one measure of performance is individual employee performance, a departmental performance average, a division performance average, a company performance average, an identification of training need, an indicator of training effectiveness, an action plan for the employee, an action plan for the department, an action plan for the division, an action plan for the company, a comparison of current performance with past action plans, a comparison of aggregated data over time for the employee, a comparison of aggregated data over time for the department, a comparison of aggregated data over time for the division, or a comparison of aggregated data over time for the company.
